(19) United States
(12) Patent Application Publication
(10) Pub. No.: US 2024/0178573 A1
(43) Pub. Date: May 30, 2024

(54) METHOD FOR DESIGNING AN ANTENNA

(71) Applicants: IMEC VZW, Leuven (BE); Universiteit Gent, Gent (BE)

(72) Inventors: Gert-Jan GORDEBEKE, Leuven (BE); Sam LEMEY, Leuven (BE); Hendrik ROGIER, Leuven (BE)

(21) Appl. No.: 18/523,134

(22) Filed: Nov. 29, 2023

(30) Foreign Application Priority Data
Nov. 29, 2022 (EP) 22210290.7

(51) Int. Cl. H01Q 13/18; H01Q 13/16

(52) U.S. Cl. CPC H01Q 13/18; H01Q 13/16

(57) ABSTRACT

A method is provided for designing an antenna comprising: i) determining dimensions of a fractional-mode, FM, air-filled, AF, antenna cavity, a FM-AF cavity, resonating around a target centre frequency characterized by a conductive ground cavity layer, a conductive top cavity layer, conductive cavity sidewalls between the top and ground cavity layer, and a side opening resulting from the fractional-mode; ii) adding a guard trace for shielding radiation from the side opening by adding sidewalls at a distance from the side opening; wherein the conductive top cavity layer is at least partially open over said distance thereby obtaining a radiating slot between the guard trace and the FM-AF cavity; wherein the FM-AF cavity and radiation slot forms an antenna cavity; iii) matching the impedance of the antenna cavity around the target centre frequency by adjusting the FM-AF and/or radiating slot dimensions within a maximum footprint.

### TECHNICAL FIELD

Various example embodiments relate to a method for designing an antenna, more particular within a certain footprint determined by the minimum free-space wavelength.

### BACKGROUND

Phase-difference-of-arrival, PDoA, is a technique wherein an emitted radio wave is received by an antenna array. By measuring the phase difference between the signals received at each of the antennas, the angle-of-arrival, AoA, can be determined. Such AoA measurements can be used by Ultra-Wide-Band, UWB, localization systems. This may for example be done in the [5.9803 GHZ, 6.9989 GHz] frequency band that covers the UWB channels 5 and 7 of the IEEE 802.15.4z standard.

To incorporate antenna elements in both 1D and 2D array configurations, a maximum inter-element distance of λₘᵢₙ/2 is required wherein λₘᵢₙ is the free-space wavelength associated with the highest frequency of operation fₘₐₓ. For the exemplary [5.9803 GHZ, 6.9989 GHz] UWB frequency band, this results in a maximum antenna element footprint of 21.4 mm×21.4 mm. Also, the mutual coupling between the elements must be minimal while maintaining a hemispherical radiation pattern. Further, for integration with electronics in a compact casing, the characteristics of the antenna should be immune to effects caused by the integration itself. Finally, to be economically viable, the antenna array should be easy to manufacture using available manufacturing techniques.

### SUMMARY

The scope of protection sought for various embodiments of the invention is set out by the independent claims.

The embodiments and features described in this specification that do not fall within the scope of the independent claims, if any, are to be interpreted as examples useful for understanding various embodiments of the invention.

Amongst others, it is an object of embodiments of the invention to provide a solution for designing and manufacturing an antenna element that fulfils at least the above-mentioned requirements.

This object is achieved, according to a first example aspect of the present disclosure, by an antenna characterized by a target centre frequency (f_{c}) and fitting within a maximum footprint of λₘᵢₙ/2 by λₘᵢₙ/2 wherein λₘᵢₙ is a given minimum free-space wavelength, the method comprising:
determining dimensions of a fractional-mode, FM, air-filled, AF, antenna cavity, an FM-AF cavity, resonating around the target centre frequency characterized by a conductive ground cavity layer, a conductive top cavity layer, conductive cavity sidewalls between the top and ground cavity layer, and a side opening resulting from the fractional-mode;
adding a guard trace for shielding radiation from the side opening by adding sidewalls at a distance from the side opening; wherein the conductive top cavity layer is at least partially open over said distance thereby obtaining a radiating slot between the guard trace and the FM-AF cavity; wherein the FM-AF cavity and radiation slot form an antenna cavity;
matching the impedance of the antenna cavity around the target centre frequency by adjusting the FM-AF and/or radiating slot dimensions within the maximum footprint.

In the first step, a resonant cavity antenna that is filled with air is dimensioned to resonate around the target centre frequency. As the cavity is filled with air, the footprint of such cavity will exceed the required maximum footprint. To address this, the footprint is further reduced by fractional-mode miniaturization that reduces the antenna dimensions to a fraction of the resonant cavity antenna thereby obtaining the dimensions of the fractional-mode air-filled antenna cavity that will fit within the maximum footprint. By fractional-mode miniaturization, the resonant cavity antenna is divided along its symmetry lines thereby obtaining a cut-out of the resonant cavity antenna. When the fraction is four, a so-called quarter-mode resonant cavity antenna is obtained that occupies one fourth of the original area. When the fraction is eight, a so-called eighth-mode resonant cavity antenna is obtained that occupies one eighth of the original area. The dimensions of the antenna cavity may further be characterized by the surface area and the height of the antenna cavity.

By the fractional-mode miniaturization some of the sidewalls of the antenna are omitted resulting in the side opening. This side opening results in lateral radiation that would negatively affect neighbouring antennas. This is addressed in the second step by foreseeing a guard trace around the side opening. Such a guard trace is a conductive side wall provided at a distance around the side opening. Along this distance, a slot is foreseen in the top conductive layer allowing radiation through the antenna cavity's top plane. As such, a hemi-spherical radiation pattern is obtained. The addition of the guard trace will again increase the footprint of the so-obtained antenna that now includes the additional area between the guard trace and the side opening. On the other hand, the introduced guard trace induces a capacitive loading effect on the cavity and thereby changes the impedance of the antenna cavity. This is addressed in the third step where the impedance of the overall antenna cavity is again matched around the target centre frequency by adjusting the dimensions of the antenna cavity. This impedance matching will on its turn result in a reduction of the overall dimensions of the antenna cavity. Thereby, the dimensions of the antenna will fit within the maximum footprint requirement.

An advantage of the design method is that an antenna is obtained that fits within the maximum λₘᵢₙ/2 by λₘᵢₙ/2 footprint. Further, as the antenna is air-filled it can achieve larger bandwidths and higher radiation efficiency than similar antennas that are filled with solid dielectrics. This makes the antenna suitable for UWB applications such as localisation, communication and sensing. Further, due to the conductive ground cavity layer the antenna will have very low radiation towards the back plane. Therefore, components integrated onto the back plane are well isolated from the antenna's radiation. As such, dimensioning the antenna can be done without having to take other platform requirements into account. Further, due to the conductive side walls, there is very little side radiation making the antenna suitable for an antenna array, such as a one- or two-dimensional antenna array.

According to example embodiments, the antenna is further characterized by a minimum bandwidth and the method further comprises:
adding an input feed into the FM-AF cavity; wherein the input feed has a probe extending into the antenna cavity that is capacitively coupled with the conductive top cavity layer;
matching the impedance of the antenna cavity over the target bandwidth by adjusting the location of the probe, the dimensions of the FM-AF cavity, and/or the capacitive coupling.

The input feed and thus the probe is not directly connected with the top cavity layer but capacitively coupled. By galvanically coupling the probe to the top cavity layer, a large fractional bandwidth cannot be achieved when maintaining the footprint of the antenna. On the one hand, even when increasing the height of the cavity, which does not impact the footprint, the achievable bandwidth improvement would saturate because of the larger feed inductance of the probe. On the other hand, by adopting the capacitively coupled probe there is no such saturation effect. As such, a large fractional bandwidth can be maintained while keeping the footprint of the antenna within the maximum footprint. Further, by adjusting the location and capacitive coupling of the probe, the impedance of the antenna can be matched again after introducing the probe.

According to example embodiments, the antenna is further characterized by at least one of a system fidelity factor, SFF, constraint, a distance estimation error, DEE, constraint, and a half-power beamwidth, HPBW, constraint; and wherein the method further comprises further adjusting the dimensions of the FM-AF cavity, and the position of the probe such that the at least one of the constraints are met.

The SFF, DEE, and HPBW are antenna design parameters that are relevant to UWB antennas and UWB antenna arrays. It has been observed that there is a trade-off between these parameters and the bandwidth of the antenna. As such, by the preceding steps, an antenna with a maximum bandwidth may be obtained within the available footprint and then these constraints can be met in exchange of bandwidth while staying in the available maximum footprint.

According to example embodiments, the antenna is further characterized by a group delay variation, GDV, constraint; the method further comprising further adjusting the capacitive coupling of the input feed such that the GDV constraint is met.

The GDV is a time-domain design parameter of an antenna. It has been observed that there is a trade-off between the GDV and the bandwidth of the antenna, and that the GDV can be further optimized by adjusting the capacitive coupling of the input feed in expense of bandwidth.

According to example embodiments, the antenna is rectangularly shaped; the FM-AF cavity is a rectangular quarter-mode, QM, cavity and two adjacent sides form the side opening; the radiation slot is L-shaped enclosing the side opening; and the antenna is characterizable by at least:
a width of the antenna cavity, W_{cav};
a length of the antenna cavity, L_{cav};
a height of the antenna cavity, h_{cav};
a length of the QM-AF cavity, L_{QM};
a width of the QM-AF cavity, W_{QM};
a length of the L-shaped radiation slot, Lₛₗₒₜ; and
a width of the L-shaped radiation slot, Wₛₗₒₜ.

According to example embodiments, the feed probe is connected to a conductive ring with radius R_{ring} and the respective conductive cavity layer has a clearance hole with radius Rₕₒₗₑ aligned with the conductive ring thereby creating the capacitive coupling.

According to example embodiments L_{QM}=W_{QM} and L_{cav}=W_{cav}. In other words, the antenna has a square shape.

According to example embodiments, the designing is further performed for a printed circuit board, PCB, production process.

The air-filled cavity allows integrating the antenna efficiently in a PCB production process as no dielectrics are required for the cavity itself. The required cavity height may be obtained by stacking different PCB layers on top of each other wherein each layer has an opening with the area of the cavity. For the conductive ground cavity layer a PCB layer with a conductive layer may be provided. For the conductive top cavity layer a PCB layer with a conductive layer may be provided wherein an opening is provided in the form of the slot. The conductive cavity sidewalls may be provided by adding a conductive layer on the formed sidewalls. The conductive cavity sidewall may also be provided by conductive vias connecting the conductive top and ground layer together.

According to further example embodiments, the conductive ground cavity layer is a first conductive layer provided on a PCB layer; the PCB layer further comprising a second conductive layer and an insulating layer between the first and second conductive layer; and wherein the input feed is provided onto the second conductive layer.

This way the input feed is integrated in the ground plane of the antenna. This further allows integrating active components on the backside of the PCB layer and thus on the backside of the antenna. As the antenna is shielded from this backside, these active components will have minimal effect on the antenna's radiation pattern and vice-versa. Further, the PCB layer may also correspond to a multi-layer PCB wherein other conductive layers are provided in the PCB layer, e.g. for carrying signals for the active components.

According to example embodiments the designing is performed for a metal stamping production process.

According to a second example aspect an antenna obtainable by the design method according to the first example aspect is provided.

According to a third example aspect an antenna array comprising at least two antennas according to the second example aspect is provided.

According to a fourth example aspect a computer program product is disclosed comprising computer-executable instructions for causing an apparatus to perform the method according to the first example aspect.

According to a fifth example aspect a computer readable storage medium is disclosed comprising computer-executable instructions for performing the method according to the first example aspect when the program is run on a computer.

### BRIEF DESCRIPTION OF THE DRAWINGS

Some example embodiments will now be described with reference to the accompanying drawings.

FIG. 1 shows steps illustrating a method for designing an antenna according to an example embodiment;

FIG. 2 shows an exploded 3D view of an air-filled antenna cavity illustrating steps for designing an antenna according to an example embodiment;

FIG. 3 shows an exploded 3D view of a quarter-mode air-filled antenna cavity illustrating steps for designing an antenna according to an example embodiment;

FIG. 4 shows an exploded 3D view of an antenna having a quarter-mode air-filled antenna cavity with guard trace and radiation slot obtainable by a method for designing an antenna according to an example embodiment;

FIG. 5 shows an exploded 3D view of an antenna having a quarter-mode air-filled antenna cavity with guard trace, radiation slot, and capacitively coupled input feed obtainable by a method for designing an antenna according to an example embodiment;

FIG. 6 shows a plot of the fractional bandwidth performance of an example antenna as a function of the cavity height;

FIG. 7 shows a plot of the SFF as a function of the cavity height, and of the GDV also as a function of the cavity height for an example antenna;

FIG. 8 shows a plot with f_{c}-SFF pairs for an example antenna;

FIG. 9 shows a plot with several FBW-GDV pairs for an example antenna;

FIG. 10 shows a 3D view of an example antenna obtainable by a method for designing an antenna according to an example embodiment;

FIG. 11 shows a 3D view of another example antenna obtainable by a method for designing an antenna according to an example embodiment;

FIG. 12 shows a bottom view of the example antenna shown in FIG. 11;

FIG. 13 shows a detail of the bottom view FIG. 12;

FIG. 14 shows an exploded 3D view of an antenna having an eighth-mode air-filled antenna cavity with guard trace, radiation slot, and capacitively coupled input feed obtainable by a method for designing an antenna according to an example embodiment;

FIG. 15 shows a variant of the antenna shown in FIG. 14;

FIG. 16 shows an exploded 3D view of an antenna having a quarter-mode air-filled antenna cavity with guard trace, radiation slot, and capacitively coupled input feed obtainable by a method for designing an antenna according to an example embodiment; and

FIG. 17 shows a computing system suitable for performing method steps according to example embodiments.

### DETAILED DESCRIPTION OF EMBODIMENT(S)

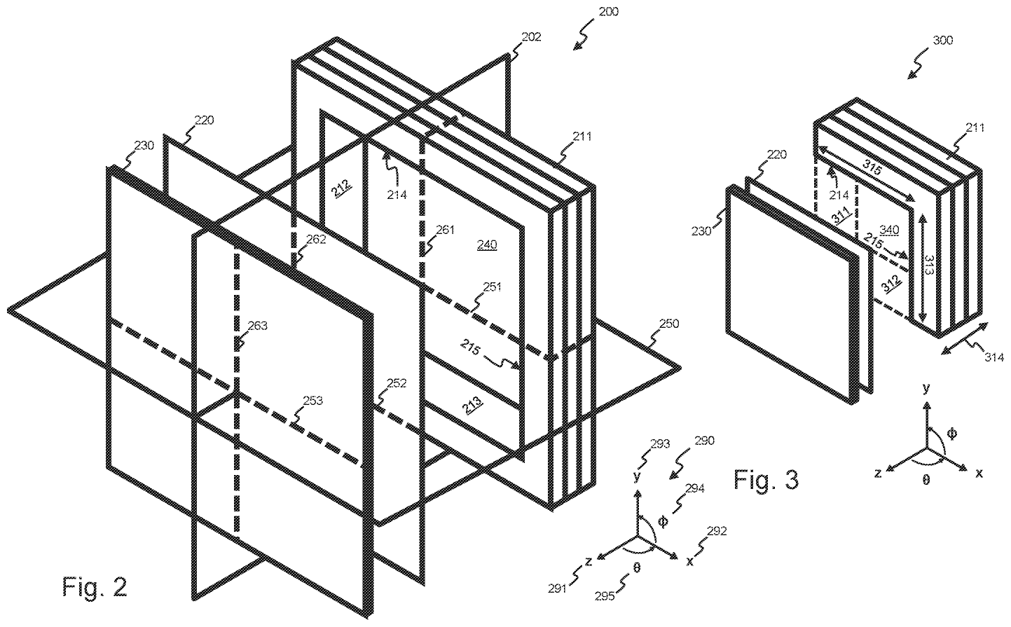

The present disclosure relates to the technical field of antennas and antenna design. The following definitions and abbreviations will be adhered to in this disclosure.
A resonant cavity antenna or antenna cavity, RCA, is an antenna device containing a space usually enclosed by metallic walls within which resonant electromagnetic fields may be excited and extracted for use as an antenna. It typically oscillates at one or more resonant frequencies with the highest amplitude.
The z-direction of a cavity-based antenna is the direction with the highest radiation intensity perpendicular to the top plane of the cavity. The x- and y-directions are perpendicular to each other and define a plane perpendicular to the z-direction. The zenith angle θ and azimuth angle ϕ are the two angles of a spherical coordinate system wherein θ=0 defines a direction coinciding with z-direction. This coordinate system is used throughout the figures and further illustrated in FIG. 2 showing z-direction 291, x-direction 292, y-direction 293, zenith angle θ (295), and azimuth angle ϕ (294). When referring to dimensions of an antenna cavity or antenna according to example embodiments, the width refers to a dimension along the x axis 292, the length refers to a dimension along the y axis 293 of the antenna, and the height refers to a dimension along the z axis 291.
Angle of arrival, AoA, refers to the direction of propagation of a radio-frequency wave impinging on a receiver. It is the angle between the negative of the propagation vector of the impinging wave to a reference direction.
Ultra-wideband, UWB, device refers to any device where the fractional bandwidth is greater than 0.2 or occupies 0.5 GHz or more of spectrum as defined by the FCC in Revision of Part 15 of the Commission's Rules Regarding Ultra WideBand Transmission Systems.
Return loss, RL, is a measure of the effectiveness of power delivery from a transmission line to a load, such as an antenna. If the power incident on the antenna is Pᵢₙ and the power reflected back to the source is P_{ref}, the degree of mismatch between the incident and reflected power in the travelling waves is given by the ratio Pᵢₙ/P_{ref}. The higher this power ratio is, the better the load and line are matched. Expressed in dB, the return loss is defined as:

RL=10×log₁₀(Pᵢₙ/P_{ref}).
Fractional impedance bandwidth, FBW: if an antenna operates at centre frequency f_{c} between a lower frequency fₘᵢₙ and an upper frequency fₘₐₓ wherein f_{c}=(fₘᵢₙ+fₘₐₓ)/2, then the fractional bandwidth FBW is given by FBW=(fₘₐₓ−fₘᵢₙ)/f_{c}.
Half-power beamwidth, HPBW, is the angular separation, in which the power of the radiation pattern decreases by 50% or −3 dB from the peak of the main beam.
Front-to-back-ratio, FTBR, is the ratio of power gain between the front and rear of the antenna, typically expressed in dB.
The system fidelity factor, SFF, is the correlation between an input pulse u(t) applied to an antenna link and its corresponding output pulse v(t) and may be expressed by the following equation:

$$SFF = {, max}_{t} \vert \frac{{\int }_{{t}_{0}}^{{t}_{n}} u ( τ ) v ( t + τ ) d τ}{\sqrt{{\int }_{{t}_{0}}^{{t}_{n}} {u}^{2} ( τ ) d τ {\int }_{{t}_{0}}^{{t}_{n}} {v}^{2} ( τ ) d τ}} \vert$$

The relative group delay variation, GDV, is the maximum deviation from the mean group delay, over the considered frequency band [fₘᵢₙ; fₘₐₓ] and may be expressed by the following equation:

$$GDV = {max}_{ω} \vert {τ}_{g} ( ω ) - \frac{1}{{ω}_{max} - {ω}_{min}} {\int }_{{ω}_{min}}^{{ω}_{max}} {τ}_{g} ( ω ) d ω \vert$$

wherein_τ_{g}(ω) is the group delay, ωₘᵢₙ=2π fₘᵢₙ, and ωₘₐₓ=2π fₘₐₓ.
The distance estimation error, DEE, is a measure for the angle-dependent waveform distortion of an antenna, which causes an angle-dependent ranging error and may be expressed by the following equation:

DEE=|tₘₐₓ(θ,ϕ)−tₘₐₓ(0, 0)|·c

wherein c is the speed of light and tₘₐₓ(θ,ϕ) is the orientation dependent time-of-arrival of a UWB pulse that maximizes the SFF in a certain direction (θ,ϕ); and wherein DEE is computed with the antenna's main direction as a reference.
Phase-difference-of-arrival, PDoA, is a technique for estimating the angle-of-arrival of a signal by calculating the signal phase differences, PD, at multiple antenna elements, incorporated in an antenna array.

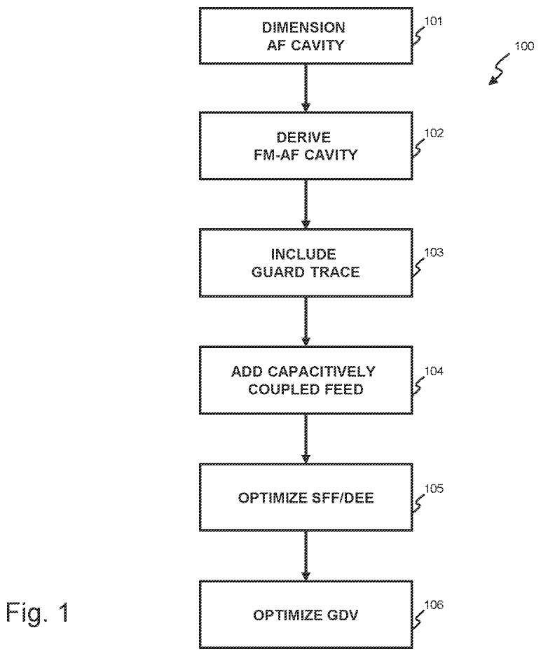

Example embodiments relate to a method for designing an UWB antenna. FIG. 1 shows steps illustrating such design method. The steps of FIG. 1 will be described with reference to FIGS. 2 to 5 illustrating antenna features obtained by the respective steps. The steps will further be illustrated for the design of an example antenna according to an example set of antenna design requirements. The example antenna is designed for operation in the [fₘᵢₙ=5.9803 GHz; fₘₐₓ=6.9989 GHz] frequency band with a target centre frequency f_{c}=6.4896 GHz. This band covers the UWB channels 5 and 7 according to the IEEE 802.15.4z standard. The return loss, for example with respect to a 50Ω impedance should exceed 10 dB in this frequency band, thereby aiming for a fractional impedance bandwidth of 15.7%. The antenna should have a hemispherical radiation pattern, a half-power beamwidth of 100° (degrees) and a front-to-back-ratio larger than 10 dB over the targeted frequency band. Further, the GDV should be below 100 ps, the SFF should exceed 98% and the DEE should be smaller than 3 cm, each within the HPBW of the antenna. Lastly, the antenna should fit within a one-dimensional, 1D, or two-dimensional, 2D, antenna array. As such, the footprint of the antenna should fit within a maximum footprint of λₘᵢₙ/2 by λₘᵢₙ/2 wherein λₘᵢₙ corresponds to the minimum free-space wavelength and is determined by the maximum frequency fₘₐₓ=6.9989 GHz. This results in λₘᵢₙ=42.8mm and a 21.4 mm by 21.4 mm maximum footprint. Lastly, the mutual coupling between two of such antennas should remain below −15 dB.

According to a first step 101, dimensions of an air-filled cavity are determined. The cavity is dimensioned such that it resonates around the specified target centre frequency f_{c}. More particular, the cavity should resonate at this frequency in its TE₁₁₀ mode, with its z-polarized electric field in the cavity varying according to one hump of a sine wave in the x-direction 292 and in the y-direction 293, while being constant in the z-direction 291. Determining dimensions of such a cavity for a certain target centre frequency f_{c} may be done by simulation software that can perform 3D electromagnetic field simulations and optimizations. In FIG. 2 the example antenna cavity 200 is shown as obtainable by first step 101. It should be understood that the antenna cavity 200 is not an intermediate step in a production process, but the result of an intermediate step in the design process of FIG. 1. The intermediate antenna 200 is merely used for understanding the design process 100.

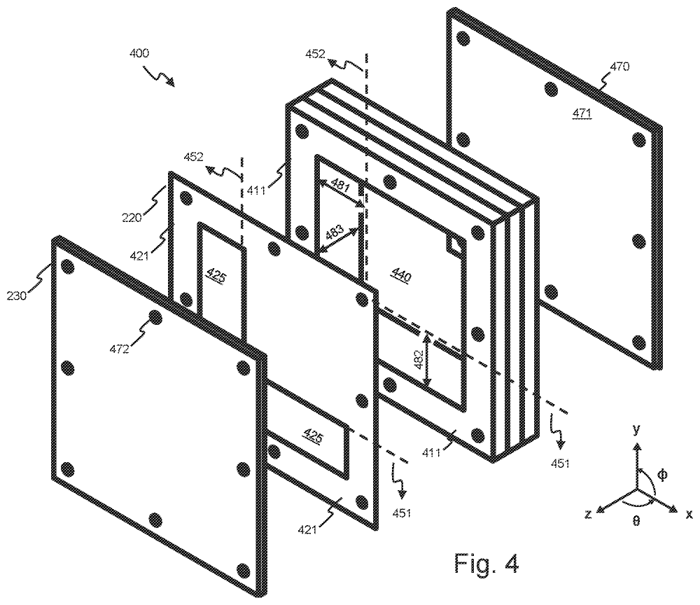

Cavity 200 has a square shape in the x-y plane with a conductive ground cavity layer (not shown in FIG. 2) and top conductive cavity layer 220. The top and ground cavity layer are connected together by conductive sidewalls 212, 213, 214, and 215. All these layers define an air-filled cavity 240. Antenna cavity 200 is further illustrated according to a printed circuit board, PCB, manufacturing process. In such process, different layers 211 can be stacked on top of each other. Each layer contains a non-conductive substrate onto which a conductive pattern may be etched. The sidewalls 212-215 may be provided by stacking different PCB layers 211 each having a square shaped opening that defines the cavity 240. The so-obtained sidewalls 212-215 may then be coated with a conductive coating to obtain the conductive sidewalls. For the top conductive cavity layer 220, another substrate layer 230 may be provided on top of the sidewall layers 211 that has another conductive layer 220 provided onto it. The ground conductive layer may be provided in a similar way (not shown in FIG. 2 and subsequent FIG. 3, shown in FIG. 4 as conductive layer 471 provided on substrate layer 470).

In a subsequent step 102, a fractional mode miniaturization is applied to the antenna cavity dimensions obtained from step 101. In this step 102, virtual magnetic walls are determined in the antenna cavity dimensioned under step 101. The dimensions of the cavity are then reduced by cutting the antenna cavity along these virtual magnetic walls into sections and keeping one of the remaining sections, thereby obtaining a fractional mode air-filled antenna cavity, in short FM-AF cavity. By this operation, the antenna footprint is reduced by a fraction according to the fractional mode miniaturization. For example, when applying a quarter-mode miniaturization the antenna footprint is reduced by a factor of four, when applying an eighth-mode miniaturization the antenna footprint is reduced by a factor of eight. Further examples of fractional mode miniaturization may be found in the publication S. Agneessens, S. Lemey, T. Vervust, and H. Rogier, “Wearable, Small, and Robust: The Circular Quarter-Mode Textile Antenna,” IEEE Antennas and Wireless Propagation Letters, vol. 14, pp. 1482 1485, 2015; and in the publication C. Jin, R. Li, A. Alphones, and X. Bao, “Quarter-Mode Substrate Integrated Waveguide and Its Application to Antennas Design,” IEEE Transactions on Antennas and Propagation, vol. 61, no. 6, pp. 2921-2928, 2013.

When applying quarter-mode miniaturization to the example antenna 200, two virtual magnetic walls 202 and 250 may be defined. Wall 202 is a symmetry plane in the yz-plane, and wall 250 is a symmetry plane in the xz-plane. Then, the antenna is cut into four portions along cutting lines 251-253 for wall 250 and along cutting lines 261-263 for wall 202. One of these sections is then retained according to step 102. The retained section for the example antenna is illustrated in FIG. 3 as a quarter-mode, QM, air-filled antenna cavity 300, in short QM-AF cavity 300, wherein quarter refers to the fact that antenna cavity 200 was divided into four sections. QM-AF cavity 300 is now characterized by its length 313, height 314, and width 315. By the quarter-mode operation, the QM-AF cavity 300 has two open sidewalls 311 and 312 defining a side opening. The air-filled cavity 340 itself has been reduced by a factor of four compared with air-filled cavity 240. After the quarter-mode miniaturization step 102, both length 313 and width 315 of the example antenna may be reduced to 17.7 mm resulting in a footprint of 17.7 mm by 17.7 mm.

As the FM-AF cavity obtained by step 102 has a side opening, electromagnetic fields along the xy-plane will no longer be shielded. As such, when integrating such antenna in an antenna array, the antenna performance will be vulnerable to undesired coupling with adjacent antennas and to integration platform effects. This will render this topology unsuitable for incorporation in the targeted compact antenna arrays. To overcome this, a guard trace is introduced in subsequent step 103. The guard trace is a conductive wall enclosing the created side opening at a certain distance such that the operation characteristics of the antenna cavity are still maintained. Over this distance, the top cavity layer is at least partially left open thereby defining a slot in the conductive top cavity layer. This slot functions as a radiation slot.

The introduction of the guard trace results in a size increase of the antenna. On the other hand, when placed in close proximity to the cavity, this causes a capacitive loading effect on the cavity. This influences matching and causes a shift of the antenna's operating frequency to a lower centre frequency. Obtaining impedance matching of the resulting antenna cavity around the target centre frequency f_{c}, requires reduction of the cavity's dimensions length L_{QM} and width W_{QM}. As such, the overall dimensions of the resulting antenna cavity defined by the original FM-AF cavity and the cavity between the side opening and the guard trace can stay within the original design requirements of the antenna. Determining the position of the guard trace may for example be done by means of a full-wave electromagnetic solver.

Returning to the example antenna, FIG. 4 shows the antenna 400 obtained from antenna 300 after introduction of the guard trace according to step 103. The line 452 illustrates the position of open sidewall 311 and line 451 illustrates the position of open sidewall 312. The portions 411, 421 of respectively the side wall layers 211 and top conductive cavity layer 220 that extend beyond these lines 451, 452 define the guard trace. The extension in width 481 and length 482 define the distance of the guard trace from the side opening. Over the distance 481 and 482, an opening 425 is provided in the top conductive cavity layer 220 thereby defining an L-shaped radiation slot 425 in the guard trace portion 421. As the layer 230 illustrates a PCB substrate layer, no slot needs to be provided therein. In FIG. 4, also the conductive ground layer is shown as a conductive layer 471 that is provided onto a PCB substrate layer 470. FIG. 4 also shows through-holes 472 that may be provided through all the PCB layers 470, 471, 211, 220, 230. Such through-holes may be used to attach and keep all layers together by means of inserted fastening means (not shown). After insertion of the guard trace 411, 421 a new antenna cavity 440 is obtained. As a result of the capacitive coupling of the guard trace, the total footprint of the antenna cavity 440 is reduced to 19 mm by 19 mm or 0.44 λₘᵢₙ by 0.44 λₘᵢₙ. The original footprint of the QM-AF cavity 340 within the cavity 440 was thereby reduced be a factor of two to 12.4 mm by 12.4 mm.

In a subsequent step 104, an input feed may be added to the so-obtained antenna cavity. The input feed may then be used to excite the TE₁₁₀ mode within the cavity 440. This may be done by a probe that extends from the top or bottom cavity layer into the cavity. The input feed may for example be a coaxial feed. To achieve impedance matching over the complete bandwidth while maintaining the same footprint, the height 483 of the antenna cavity 440 may be increased such that the Q-factor of the antenna is decreased. By increasing the height 483, also the probe feed length will increase. This increase results in a larger feed inductance, making impedance matching more difficult. Due to this effect, the maximum achievable fractional bandwidth is limited to around 10%, which may be too low for certain UWB applications such as the example antenna requirements, which require 15.7%. In order to overcome this saturating effect, the input feed is configured such that the probe is capacitively coupled with the antenna cavity, for example through the ground or top layer. When introducing the capacitively coupled feed, the amount of capacitive coupling, the location of the probe and/or the dimensions of the FM-AF cavity may be further tuned while keeping the overall footprint of the antenna fixed. This tuning may for example be done by performing full-wave simulations. By the capacitive coupling of the probe, the achieved bandwidth will now increase with an increased cavity height. In practice, the available fractional bandwidth may exceed 30%.

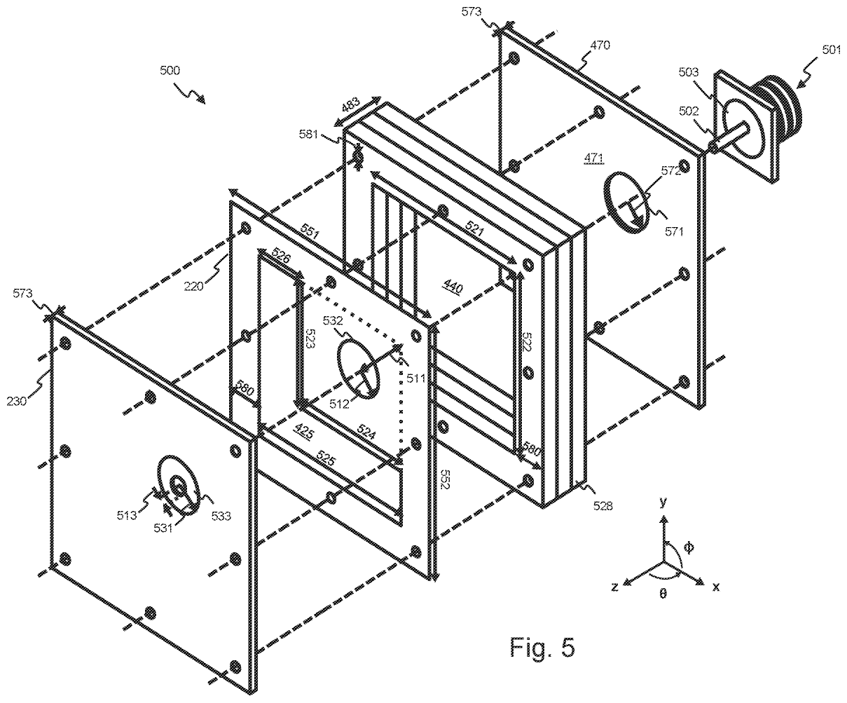

The introduction of the capacitively coupled input feed according to step 104 is further illustrated for the example antenna in FIG. 5. The antenna 500 now has a coaxial input feed 501 containing a probe 502 with probe radius 513, R_{probe}, that extends into the cavity 440 along the z-direction. The probe 502 is provided into a hole 571 provided in the ground conductive cavity layer 471 and corresponding substrate layer 470. The coaxial feed further comprises an isolating material 503 such that the input probe 502 is not in conductive contact with the conductive ground layer 471. A similar through-hole 532, characterized by its radius 512, Rₕₒₗₑ, is provided in the top conductive cavity layer 220. The probe 502 then connects to a conductive circular portion 533 provided on top of substrate layer 230. The circular portion 533 is characterized by a certain radius 531, R_{ring}. Rₕₒₗₑ and R_{ring} can be tuned to achieve the required capacitive coupling between the probe 502 and the top conductive cavity layer 220. The location of the probe may be chosen within the QM-AF cavity portion of the antenna 500, for example by a selectable distance 511, d_{feed}. When applying step 104 to the example antenna 500, the target antenna bandwidth can be achieved by increasing the cavity height 483, h_{cav} while tuning the dimensions of the QM-AF cavity 340, i.e. the QM-AF cavity width 524, W_{QM}, and QM-AF cavity length 523, L_{QM}, tuning the location of the probe 502 characterized by d_{feed} 511; and tuning the capacitive coupling characterized by R_{ring} 531 and Rₕₒₗₑ 512. The overall antenna footprint is then characterized by the cavity length 522, L_{cav}, and the cavity width 521, W_{cav}. The tuning parameters may for example by obtained by performing full-wave simulations of the antenna. For the example antenna, a cavity height h_{cav}≥4 mm may be selected while keeping the cavity dimensions fixed at L_{cav}×W_{cav}=19 mm×19 mm. The so-obtained symmetry of the example antenna 500 with respect to the φ=45°-plane leads to a linearly polarized antenna with its co-polarization and cross-polarization axis along the φ=45°- and φ=135°-plane, respectively.

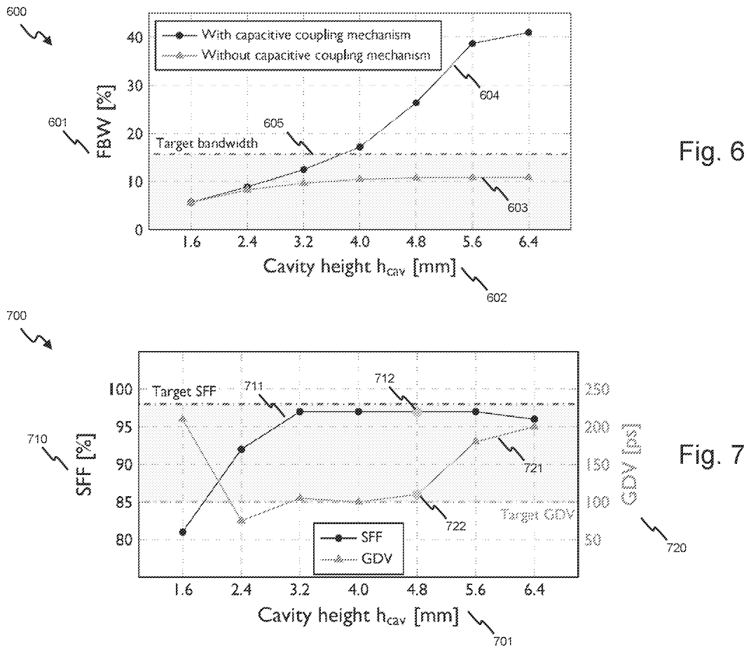

FIG. 6 shows a plot 600 of the fractional bandwidth 601 performance of the example antenna as a function of the cavity height h_{cav} 602. A first curve 603 illustrates the fractional bandwidth 601 of the antenna 500 without capacitively coupled input feed, i.e. wherein Rₕₒₗₑ=R_{probe}. A second curve 604 illustrates the fractional bandwidth 601 for the antenna 500 having the capacitively coupled input feed. As can be derived from the curve 604, the antenna 500 surpasses the fractional bandwidth requirement 605 of 15.7% when selecting a cavity height h_{cav}≥4 mm.

After introducing the capacitively coupled feed according to step 104, the time-domain performance parameters may be further optimized until the specified values are reached according to subsequent steps 105, and 106.

To perform the optimization steps 105, 106, a free-space antenna link may be simulated with the so-obtained antenna, e.g. antenna 500, at both the transmit and receive side with a certain distance between both antennas, e.g. 1 m. The simulations then evaluate the SFF, the GDV and the DEE for different angles of departure and arrival in the positive hemisphere, i.e. z>0, of the transmit and receive antenna, respectively. Simulations may be performed by full-wave simulations of the individual antennas and by applying a root raised cosine, RRC, pulse to the antenna link to assess the introduced pulse distortion. Specifically, for the example antenna, the reference RRC pulses for UWB transmitters in UWB channels 5 and 7 may be applied as defined in IEEE Std 802.15.4-2020. These normalized pulse amplitudes modulate a carrier sine wave, (1+r(t))·sin(2πf_{c}t), after which their amplitude is normalized again.

In step 105, the optimal values for the cavity height, the QM-AF cavity width and length, and the location of the capacitively coupled feed are further tuned to achieve the SFF and DEE criteria within the targeted bandwidth. Returning to the example antenna 500, this may be done by respectively tuning the cavity height h_{cav}, the QM-AF dimensions L_{QM}=W_{QM}, and d_{feed}.

According to an example embodiment, in the next step 106, the capacitive coupling is further adjusted until the GDV constraint is met. Returning to the example antenna 500, this may be done by respectively adjusting the Rₕₒₗₑ and R_{ring} parameters.

Optimization steps 105 and 106 will now be further described for the example antenna 500.

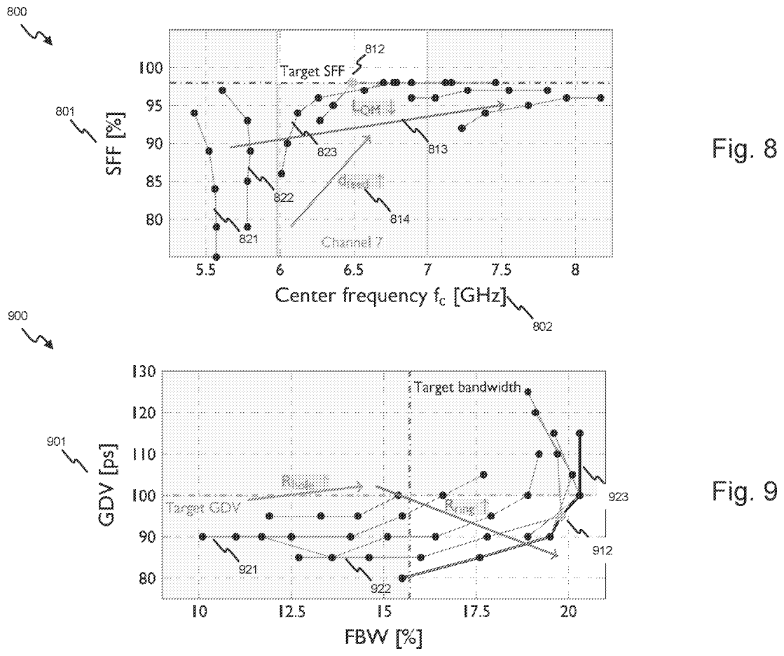

Step 105 considers h_{cav}, L_{QM}=W_{QM} and d_{feed}. Plot 700 of FIG. 7 shows a first curve 711 illustrating the SFF 710 as a function of the cavity height h_{cav} 701. Plot 700 further shows a second curve 721 illustrating the GDV 720 also as a function of the cavity height h_{cav} 701. From plots 600 and 700 it may be derived that h_{cav}≥4 mm is necessary to achieve the targeted bandwidth but larger cavity heights of h_{cav}≥5.6 mm lead to quickly deteriorating time-domain performance of GDV and SFF. Plot 800 in FIG. 8 shows a set of f_{c}-SFF pairs, e.g. 821, 822, 823 . . . , obtained by sweeping the L_{QM}=W_{QM} and the d_{feed} parameters simultaneously while keeping the antenna footprint and slot length Lₛₗₒₜ constant. According to plot 800 it can be derived that decreasing L_{QM}=W_{QM} (line 813) or increasing d_{feed} (line 814) can considerably increase the SFF 801. However, within the maximum footprint of 21.4 mm by 21.4 mm, this results in an upward shift of the operating frequency band, with centre frequency f_{c} 802, as illustrated in plot 800. This shows that increasing d_{feed} generally increases the SFF 801. On the other hand, the QM-AF dimensions L_{QM}=W_{QM} also influence the SFF criterion. For larger L_{QM}=W_{QM} values the SFF criterion can no longer be met while smaller values cause the operating frequency f_{c} 802 to shift upwards and outside of the targeted frequency band. By simultaneously considering h_{cav}, L_{QM}=W_{QM} and d_{feed} in 105 and optimizing for the high SFF criterion and low DEE criterion over the targeted HPBW, a stable radiation pattern is attained over the operating frequency band, leading to a highly efficient antenna element with a near frequency-independent hemispherical radiation pattern with large HPBW and FTBR in the required footprint. This optimization step results in final values of L_{QM}=W_{QM}=12.4 mm, d_{feed}=8.9 mm, and h_{cav}=4.8 mm. The corresponding optimization results are indicated in plots 700 and 800 by dots 712, 722, and 812.

According to step 106, the capacitive coupling mechanism is optimized further to tune the phase of the antenna's input impedance to minimize the GDV of the antenna 500. As such, the capacitive coupling mechanism, controlled by Rₕₒₗₑ and R_{ring}, may not only be used to enhance the antenna bandwidth, but also to minimize its GDV. The trade-off between meeting the GDV constraint and covering the targeted frequency band is further illustrated in plot 900 in FIG. 9. Plot 900 shows several FBW-GDV pairs 921, 922 . . . generated by simultaneously sweeping the Rₕₒₗₑ and R_{ring} parameters, while keeping the cavity size, slot length and previously determined h_{cav}, L_{QM}=W_{QM} and d_{feed} parameters constant. In general, increasing Rₕₒₗₑ increases both FBW and GDV. Increasing R_{ring} enhances the FBW while simultaneously reducing the GDV, provided that Rₕₒₗₑ is properly adjusted to prevent the GDV from sharply increasing. The resulting pareto-front 923 is also shown in plot 900 with the Pareto-optimal solution 912. Selecting this solution 912 results in the final antenna dimensions, yielding high bandwidth and large HPBW while satisfying the requirements for the time domain system-level characteristics for the example antenna. The final dimensions for the optimized example antenna element 500 are shown in the below Table 1. The first column shows the parameter name, the second column the reference number illustrating the parameter in the figures, and the third columns the selected dimension specified in mm (millimetres).

TABLE 1
Values of antenna 500 design parameters

| Parameter | (reference number) | Dimension (mm) |
|---|---|---|
| L | 552 | 25 |
| W | 551 | 25 |
| L_{cav} | 522 | 19 |
| W_{cav} | 521 | 19 |
| Lₛₗₒₜ | 525 | 19 |
| Wₛₗₒₜ | 526 | 6.6 |
| d_{wall} | 580 | 3 |
| d | 581 | 1 |
| d_{feed} | 511 | 8.9 |
| L_{QM} | 523 | 12.4 |
| W_{QM} | 524 | 12.4 |
| R_{probe} | 513 | 0.65 |
| R_{ring} | 531 | 1.5 |
| Rₕₒₗₑ | 512 | 2.1 |
| R_{conn} | 572 | 2.2 |
| h_{cav} | 483 | 4.8 |
| h_{sub} | 573 | 0.25 |

Example antenna 500 may be produced by a suitable PCB production process. An advantage of the proposed antenna method is that it can be produced in a straightforward manner using such widely available PCB production processes. For the cavity 440, three 1.55 mm-thick FR4 substrates may be used. The sides may be plated with metal to form the conductive sidewalls. For this, a square cavity 440 can be milled out in the three PCB layers 528, 211 which are then plated on all sides by round-edge plating. A 0.25 mm-thick two-layer Rogers RO4350b laminate (εᵣ=3.66 and tan δ=0.0037) can be applied as the top and bottom substrate layer 230, 470. The bottom metal layer 220 of the top Rogers high-frequency laminate implements the top metal layer of the cavity 440, containing the L-shaped slot 425 and a clearance hole 532 for the input probe 502 of the input feed 501. Its top metal layer realizes the annular ring 533 to achieve the capacitive coupling. The top metal layer of the bottom Rogers high-frequency laminate substrate layer 470 implements the bottom metal layer of the cavity. Its bottom metal layer can contain a solder platform that is connected to its top layer using via rows. This solder platform facilitates the assembly of the coaxial feed, for which a straight square flange mount coaxial connector can be used. Its outer conductor is soldered to the solder platform and its inner conductor, i.e. probe 502, to the annular ring 533.

The bottom of the laminate 470 can further be used to compactly integrate active components, such as a UWB transceiver and microcontroller, thereby further reducing interconnection losses and system footprint. This further allows connecting multiple antennas together to form compact and high-performance active multi-antenna systems for AoA estimation, beamforming, and sensing.

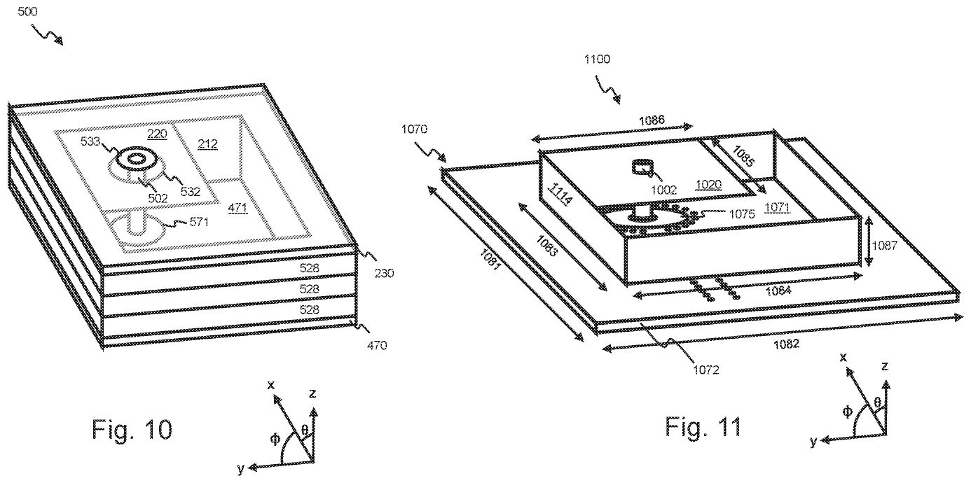

FIG. 10 illustrates example antenna 500 after assembly using the reference numbers already introduced in FIGS. 2 to 5. Gray lines are not visible from the top as the top laminate layer 230 is normally not transparent.

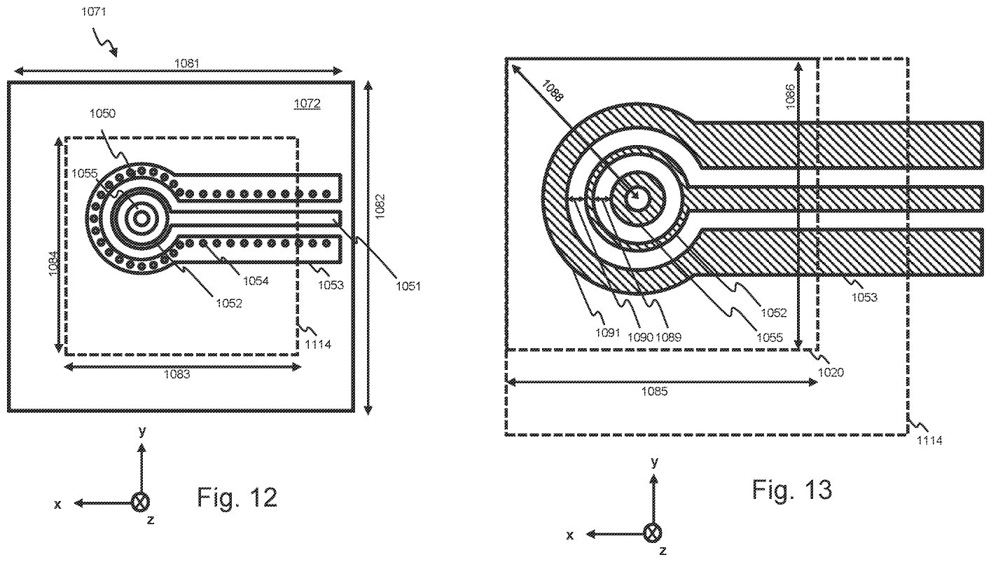

FIG. 11 shows a three-dimensional view of a second example antenna 1100 obtainable by the design method according to FIG. 1. FIG. 12 shows a bottom view of this antenna 1100, i.e., shows the underside of the bottom layer 1071. FIG. 13 shows an enlarged view of the active antenna area defined by antenna walls 1114. In FIG. 13, the conductive parts are hatched, and the non-conductive parts are left unhatched. Similar to the first example antenna, antenna 1100 comprises a ground conductive cavity layer 1072, a top conductive cavity layer 1020 and conductive cavity sidewalls 1114. The volume between the conductive side walls defines the antenna cavity. Within this antenna cavity, the volume underneath the top conductive cavity layer 1020 defines the quarter-mode antenna cavity. The remaining volume in the antenna cavity then defines the radiating slot.

A difference with the first example antenna 500 is that the conductive side walls and conductive top layer are provided as an arrangement of conductive sheets. Such arrangement may for example be obtained by a metal stamping process. The so-obtained metal sheets may then be provided onto a bottom layer 1070.

Another difference is that the capacitively coupling as obtained according to step 104 of FIG. 1 is implemented at the bottom layer 1070 instead of at the conductive top layer. To this purpose, the bottom layer 1070 comprises a non-conductive substrate 1072 with the ground conductive cavity layer 1071 on one side. On the other side an input feed 1050 is provided. Input feed 1050 comprises a conductive input line 1051 provided onto the substrate. At one end, this line is connectable to the antenna signal either as input or output. At the other end, the line 1051 connects to a conductive circular section 1052. Input feed 1050 further comprises a second conductive strip 1053 at a distance from line 1051 and section 1052. This conductive circular section is coupled with vias 1054 through the substrate with the ground conductive cavity layer 1071 and thereby forms a grounded co-planar waveguide, GCPW, trace to carry the electromagnetic antenna feed signal into or from the circular section 1052. Input feed 1050 further comprises a second inner conductive circular ring 1055 provided within the first circular section 1052. This second ring 1055 is galvanically connected to the probe 1002 that extends into the antenna cavity. Further, a clearance hole 1075 is foreseen in the ground conductive cavity layer 1071 to avoid galvanic contact between probe 1002 and layer 1071.

The characterizing parameters and dimensions of the antenna 1100 can then be defined as follows:
The dimensions of the antenna 1100 characterized by the PCB width 1081 and length 1082;
The dimensions of the antenna cavity characterized by the antenna cavity width 1083, antenna cavity length 1084 and cavity height 1087;
The dimensions of the QM-cavity characterized by the QM-cavity width 1085 and QM cavity length 1086;
The dimensions of the radiating slot characterized by the difference between the antenna cavity and QM-cavity;
The position of the input feed 1050 characterized by the feed distance 1088;
The amount of capacitive coupling characterized by the distance 1089 between the first and second circular members 1052 and 1055;
The distance 1090 between the first circular member 1052 and outer circular member 1091;
The size of clearance hole 1075; and
The trace width of the circular members 1052 and 1055.
   These parameters and dimensions may be obtained by applying the design steps as described with reference to FIG. 1.

The above-described example antennas 500 and 1100 are rectangularly shaped and use a quarter-mode antenna cavity. The described design method is not limited to such shapes and may also be applied to design a circularly or elliptically shaped antenna. The described design method is also not limited to a quarter-mode antenna cavity and may use other fractional-modes, e.g., an eighth-mode antenna cavity.

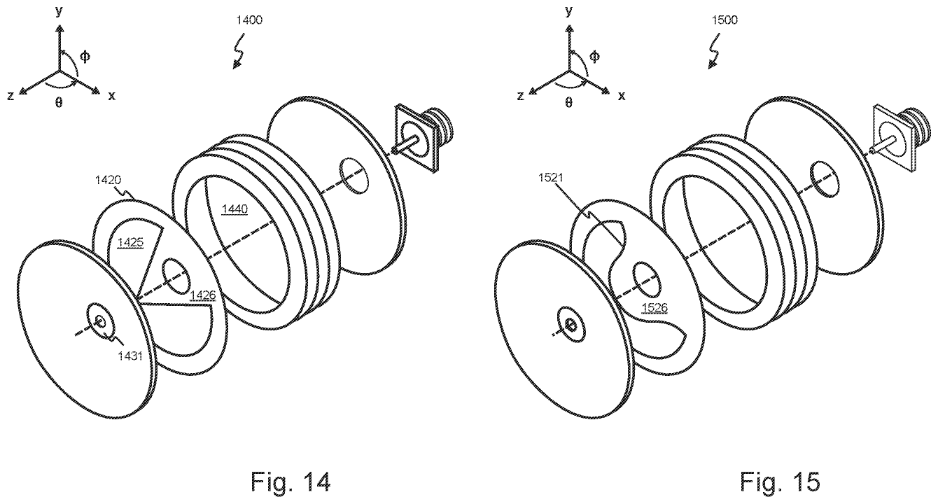

FIG. 14 shows an exploded view of an antenna 1400 similar to the exploded view of the antenna 500 in FIG. 5. The difference is that antenna 1400 is based on a circular air-filled cavity antenna onto which an eighth-mode miniaturization has been applied according to steps 101 and 102. This results in a tubular antenna cavity 1440, wherein the eighth-mode miniaturization defines a conductive top plate section 1426 that is one-eighth of the cavity's surface. The remaining section 1425 remains open and defines the radiation slot of the antenna 1400.

FIG. 15 shows an exploded view of an antenna 1500. Antenna 1500 is a variant of antenna 1400 wherein the edges or borders 1521 of the conductive top plate section 1526 have been rounded according to a spline shape.

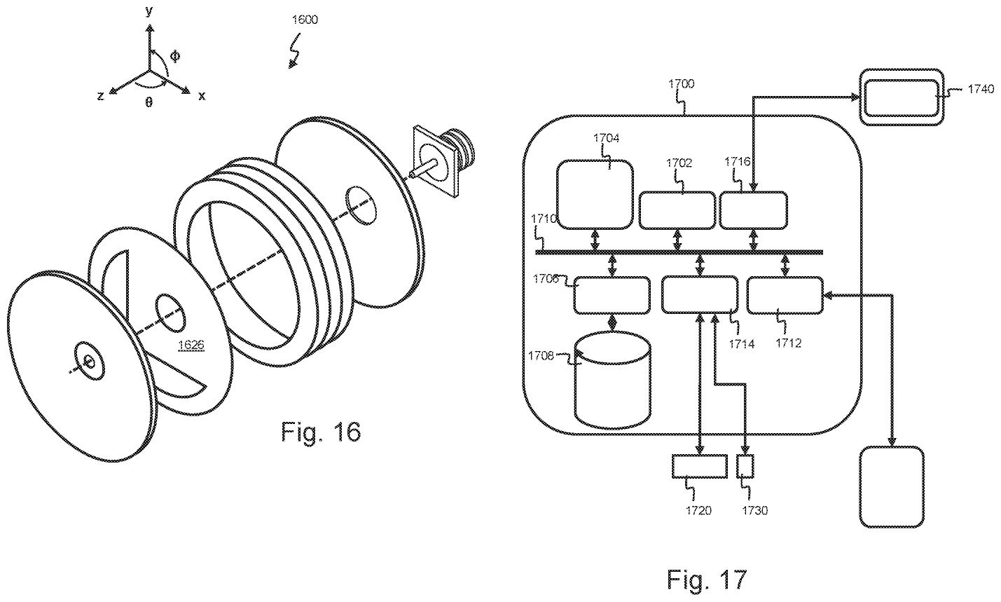

FIG. 16 shows an exploded view of an antenna 1600. Antenna 1600 is a variant of antenna 1400 with the difference that a quarter-mode miniaturization has been applied in accordance with step 102 instead of an eighth-mode miniaturization. This quarter-mode miniaturization defines a conductive top plate section 1626 that is a quarter of the cavity's surface.

Antenna dimensions as obtained by the method described with reference to FIG. 1 may be used for antenna manufacturing. One technique is PCB manufacturing as described with reference to FIGS. 4 and 5. In FIGS. 4 and 5, through-holes 472 are provided for holding the different layers together by means of mechanical fastening means, e.g., a rod. As an alternative, the different PCB layers may be held together by an adhesive, e.g. soldering paste, or prepreg layer. In FIGS. 4 and 5, a square is provided in each PCB layer to obtain the antenna cavity. As an alternative, the cavity may be cut or milled out after stacking and fixing the layers together.

Another technique is metal stamping as described with reference to the antenna 1100 in FIG. 11. When using metal stamping, a shape is cut out from a metal plate and plied into the desired form. The stamped shape then defines the conductive side walls 1114, conductive top plate 1020 and radiation slot. The stamped shape is then attached to a PCB layer with conductive top and bottom layers. The attachment may be achieved by soldering the stamped shape onto the PCB layer. Also, one or more pins may be formed on the side walls that extent through the PCB layer and soldered on the bottom side of the PCB layer.

Also, other fabrication techniques may be used such as 3D-printing, Laser Direct Structuring and Molded Interconnect Devices (LDS/MID), silicon micromachining, or any combination thereof.

The design method steps according to FIG. 1 may be performed by a suitable computing system. FIG. 17 shows such a suitable computing system 1700 that enables performing the design steps according to the above-described embodiments. Computing system 1700 may in general be formed as a suitable general-purpose computer and may comprise a bus 1710, a processor 1702, a local memory 1704, one or more optional input interfaces 1714, one or more optional output interfaces 1716, a communication interface 1712, a storage element interface 1706, and one or more storage elements 1708. Bus 1710 may comprise one or more conductors that permit communication among the components of the computing system 1700. Processor 1702 may include any type of conventional processor or microprocessor that interprets and executes programming instructions. Local memory 1704 may include a random-access memory (RAM) or another type of dynamic storage device that stores information and instructions for execution by processor 1702 and/or a read only memory (ROM) or another type of static storage device that stores static information and instructions for use by processor 1702. Input interface 1714 may comprise one or more conventional mechanisms that permit an operator or user to input information to the computing device 1700, such as a keyboard 1720, a mouse 1730, a pen, voice recognition and/or biometric mechanisms, a camera, etc. Output interface 1716 may comprise one or more conventional mechanisms that output information to the operator or user, such as a display 1740, etc. Communication interface 1712 may comprise any transceiver-like mechanism such as for example one or more Ethernet interfaces that enables computing system 1700 to communicate with other devices and/or systems. The communication interface 1712 of computing system 1700 may be connected to such another computing system by means of a local area network (LAN) or a wide area network (WAN) such as for example the internet. Storage element interface 1706 may comprise a storage interface such as for example a Serial Advanced Technology Attachment (SATA) interface or a Small Computer System Interface (SCSI) for connecting bus 1710 to one or more storage elements 1708, such as one or more local disks, for example SATA disk drives, and control the reading and writing of data to and/or from these storage elements 1708. Although the storage element(s) 1708 above is/are described as a local disk, in general any other suitable computer-readable media such as a removable magnetic disk, optical storage media such as a CD or DVD, -ROM disk, solid state drives, flash memory cards, . . . could be used.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the scope of the claims are therefore intended to be embraced therein.

It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, “third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A method for designing an antenna characterized by a target centre frequency, f_{c}, and fitting within a maximum footprint of λₘᵢₙ/2 by λₘᵢₙ/2 wherein λₘᵢₙ is a given minimum free-space wavelength associated with a highest frequency of operation, fₘₐₓ, the method comprising:
determining dimensions of a fractional-mode, FM, air-filled, AF, antenna cavity, an FM-AF cavity, resonating around the target centre frequency characterized by a conductive ground cavity layer, a conductive top cavity layer, conductive cavity sidewalls between the top and ground cavity layer, and a side opening resulting from the fractional-mode;
adding a guard trace for shielding radiation from the side opening by adding sidewalls at a distance from the side opening; wherein the conductive top cavity layer is at least partially open over said distance thereby obtaining a radiating slot between the guard trace and the FM-AF cavity; wherein the FM-AF cavity and radiation slot form an antenna cavity;
matching the impedance of the antenna cavity around the target centre frequency by adjusting the FM-AF cavity and/or radiating slot dimensions within the maximum footprint.

2. The method according to claim 1, wherein the dimensions comprise a surface area of the FM-AF cavity and a height of the FM-AF cavity.

3. The method according to claim 1, wherein, by adding the guard trace, inducing a capacitive loading on the FM-AF cavity thereby lowering a centre frequency of the antenna;
and wherein the matching comprises reducing the dimensions.

4. The method according to claim 1, wherein the antenna is further characterized by a minimum bandwidth; the method further comprising:
adding an input feed into the FM-AF cavity; wherein the input feed has a probe extending into the antenna cavity that is capacitively coupled with the conductive top cavity layer;
matching the impedance of the antenna cavity over the target bandwidth by adjusting the location of the probe, the dimensions of the FM-AF cavity, and/or the capacitive coupling.

5. The method according to claim 4, wherein the antenna is further characterized by at least one of a system fidelity factor, SFF, constraint, a distance estimation error, DEE, constraint, and a half-power beamwidth constraint; and wherein the method further comprises:
further adjusting the dimensions of the FM-AF cavity, and the position of the probe such that the at least one of the constraints are met.

6. The method according to claim 4, wherein the antenna is further characterized by a group delay variation, GDV, constraint; the method further comprising:
further adjusting the capacitive coupling of the input feed such that the GDV constraint is met.

7. The method according to claim 4, wherein the antenna is rectangularly shaped; wherein the FM-AF cavity is a rectangular quarter-mode, QM, cavity and two adjacent sides form the side opening; wherein the radiation slot is L-shaped enclosing the side opening; and wherein the antenna is characterizable by at least:
a width of the antenna cavity, W_{cav};
a length of the antenna cavity, L_{cav};
a height of the antenna cavity, h_{cav};
a length of the QM-AF cavity, L_{QM};
a width of the QM-AF cavity, W_{QM};
a length of the L-shaped radiation slot, Lₛₗₒₜ; and
a width of the L-shaped radiation slot, Wₛₗₒₜ.

8. The method according to claim 7, wherein the feed probe is connected to a conductive ring with radius R_{ring} and the respective conductive cavity layer has a clearance hole with radius Rₕₒₗₑ aligned with the conductive ring thereby creating the capacitive coupling.

9. The method according to claim 7, wherein L_{QM}=W_{QM} and L_{cav}=W_{cav}.

10. The method according to claim 1, wherein the designing is performed for a printed circuit board, PCB, production process.

11. The method according to claim 10, wherein the conductive ground cavity layer is a first conductive layer provided on a PCB layer; the PCB layer further comprising a second conductive layer and an insulating layer between the first and second conductive layer; and
wherein the input feed is provided onto the second conductive layer.

12. The method according to claim 1, wherein the designing is performed for a metal stamping production process.

13. An antenna obtainable by the method according to claim 1.

14. An antenna array comprising at least two antennas according to claim 13.

15. A computer program product comprising computer-executable instructions for causing an apparatus to perform the method according to claim 1.

16. A computer readable storage medium comprising computer-executable instructions for performing the method according to claim 1 when the program is run on a computer.
